(19) United States
(12) Patent Application Publication
(10) Pub. No.: US 2011/0235463 A1
(43) Pub. Date: Sep. 29, 2011

(54) MIXING APPARATUS

(75) Inventors: Brian Justusson, Northville, MI (US); John Lyons, Ann Arbor, MI (US); Barrett Hall, Lake Orion, MI (US); Kara Morris, Allston, MA (US)

(73) Assignee: DOMINO'S PIZZA PMC, INC., Ann Arbor, MI (US)

(21) Appl. No.: 12/748,593

(22) Filed: Mar. 29, 2010

(51) Int. Cl. B01F 7/00

(52) U.S. Cl. 366/247

(57) ABSTRACT

A mixer according to the present disclosure may include a container for receiving material to be mixed, and a mixing assembly configured to extend into the container. The mixing assembly may include a rotatable shaft and multiple blade units connected to the shaft. Furthermore, each blade unit may include multiple parallel blades.

### TECHNICAL FIELD

The present disclosure relates to a mixing apparatus for mixing material.

### BACKGROUND

Prior apparatuses have been developed for mixing materials. U.S. Publication No. 2007/0177453, for example, discloses a hand held immersion mixer that includes an electric motor, a drive shaft, a tube, a bell-shaped housing and a rotary tool. U.S. Pat. No. 6,513,967 discloses another example of an electric powered hand mixer.

### SUMMARY

A mixer according to the present disclosure may include a container for receiving material to be mixed, and a mixing assembly configured to extend into the container. The mixing assembly may include a rotatable shaft and multiple blade units connected to the shaft. Furthermore, each blade unit may include multiple parallel blades.

While exemplary embodiments are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a side view of a mixer according to the present disclosure, which includes a container arrangement a mixing assembly associated with the container arrangement, wherein a portion of the container arrangement is broken away to show multiple blade units of the mixing assembly;

FIG. 2 is an exploded side view of the mixer;

FIG. 3 is a perspective view of a portion of the mixing assembly showing three blade units attached to a rotatable shaft;

FIG. 4 is a cross-sectional view of one of the blade units; and

FIG. 5 is a bottom view of the mixing assembly.

### DETAILED DESCRIPTION

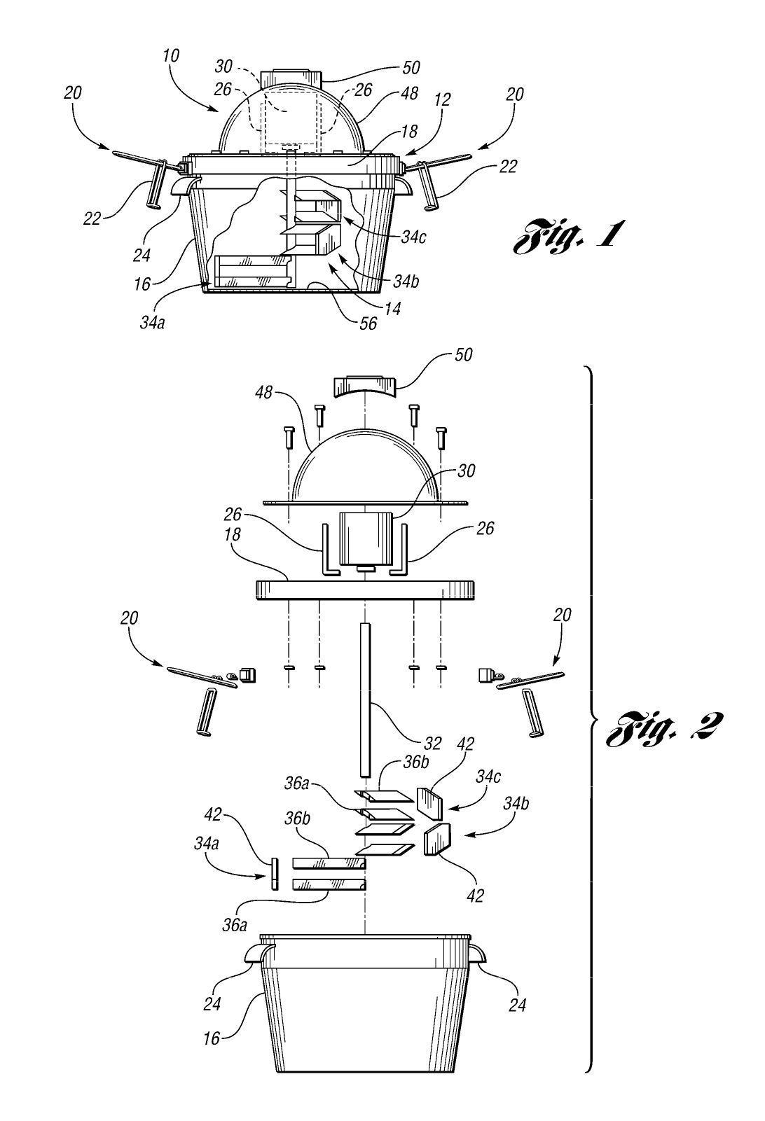

The present disclosure describes various apparatuses for mixing materials, such as pizza sauce, for example. Several specific embodiments are set forth in the following description and in FIGS. 1-5 to provide a thorough understanding of certain embodiments according to the present disclosure. As those of ordinary skill in the art will understand, various features of the embodiments illustrated and described with reference to any one of the Figures may be combined with features illustrated in one or more other Figures to produce embodiments that are not explicitly illustrated or described. In addition, other embodiments may be practiced without several of the specific features explained in the following description.

FIG. 1 shows a mixing apparatus or mixer 10 according to the present disclosure for mixing materials, such as concentrated pizza sauce and water, or any other suitable materials. The mixer 10 includes a container arrangement 12 for receiving material to be mixed, and a mixing assembly 14 configured to extend into the container arrangement 10 for mixing material inside the container arrangement 10.

The container arrangement 10 includes a main portion or container 16, and a lid or cover 18 that is attachable to the container 16. The container 16 and/or cover 18 may also be provided with a sealing member, such as a silicone gasket (not shown) for sealing the cover 18 to the container 16 to prevent material from being ejected from the container 16 during operation. While the container 16 may have any suitable size and shape, in the embodiment shown in FIG. 1, the container 16 is generally cylindrical and has an inside diameter in the range of 10 to 14 inches. As a more specific example, the container 16 may have a generally circular cross-section that increases in size as a function of container height, such that the inside diameter at or near the bottom of the container 16 is approximately 12.1875 inches, and the inside diameter at or near the top of the container 16 is 12.3125 inches.

The cover 18 may be attached to the container 16 in any suitable manner. For example, the cover 18 may be configured to snap fit onto the container 16. Alternatively or supplementally, the cover 18 may be removably attached to the container 16 with one or more latches 20. In the embodiment shown in FIG. 1, the container arrangement 12 includes two latches 20 mounted on the cover 18, and each latch 20 has an engaging portion 22 that is engageable with a receiving portion, such as a handle 24, of the container 16. In another embodiment, the container arrangement 12 may include one or more latches mounted on the container 16 and that are engageable with the cover 18. In yet another embodiment, the container arrangement 12 may include one or more spring loaded latches mounted on the container 16 or cover 18 and that are biased toward a latching position.

Referring to FIGS. 1 and 2, the mixing assembly 14 may be attached directly to the cover 18. For example, the mixing assembly 14 may include one or more support members, such as brackets 26, that are attached to the cover 18 in any suitable manner, such as by a welding operation and/or with fasteners 28. As another example, the mixing assembly 14 may be attachable directly to the container 16. With such a configuration, the mixer 10 may be provided with or without cover 18.

Referring to FIGS. 1 through 3, the mixing assembly 14 may include a motor, such as an electric motor 30, mounted on the brackets 26, a rotatable shaft 32 connected to the motor 30, and multiple blade units 34 connected to the shaft 32. In one embodiment, for example, the shaft 32 may be connected to an output shaft of the motor 30 using a cotter pin and/or a threaded connection.

While the mixing assembly 14 may have any suitable number of blade units 34, in the embodiment shown in FIGS. 1 through 3, the mixing assembly 14 includes three blade units 34, such as first, second and third blade units 34a, 34b and 34c, respectively. Furthermore, each blade unit 34 includes multiple, spaced apart parallel blades 36 that are each angled downwardly. For example, each blade 36 may be angled downwardly at least twenty-five degrees relative to a horizontal line. As another example, each blade 36 may be angled downwardly by about thirty degrees relative to a horizontal line.

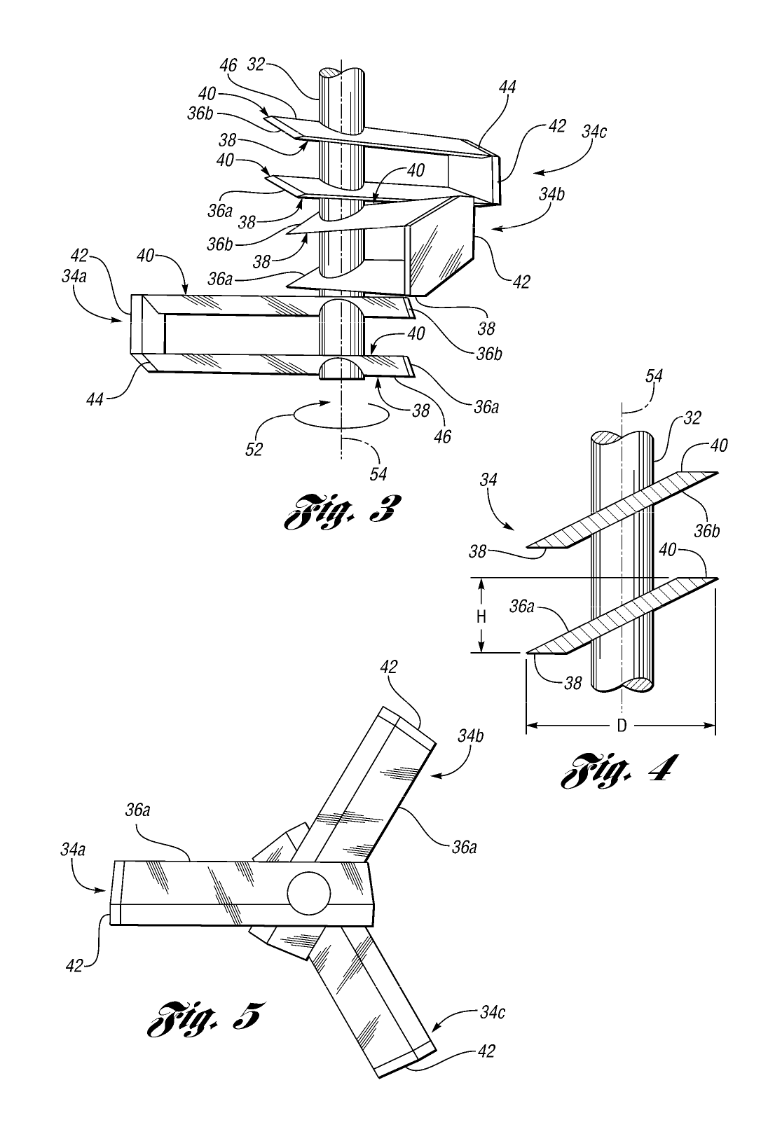

Referring to FIGS. 1 and 3, the blade units 34 may be offset vertically with respect to each other. Portions of adjacent blade units 34, however, may be generally aligned with each other. In the embodiment shown in FIGS. 1 and 3, for example, each blade unit 34 includes two blades 36, such as lower and upper blades 36a and 36b, respectively, and each blade has a generally horizontal lower edge 38 and a generally horizontal upper edge 40. Referring to FIG. 3, the upper edge 40 of the upper blade 36b of the first blade unit 34a is generally coplanar with the lower edge 38 of the lower blade 36a of the second blade unit 34b, and the upper edge 40 of the upper blade 36b of the second blade unit 34b is generally coplanar with the lower edge 38 of the lower blade 36a of the third blade unit 34c. For example, adjacent edges 40 and 38 of adjacent blade units 34 may separated by 0.35 inches or less. With such a configuration, the mixing assembly 14 may provide improved screw-type mixing action.

As another example, the blade units 34 may overlap each other. As yet another example, the blade units 34 may be positioned generally at the same height.

Each blade unit 34 may also include a connector member 42, such as an end cap, that connects distal first ends 44 of the associated blades 36a,b. Each connector member 42 may reduce flexing of the associated blades 36a,b such that each blade unit 34 may be relatively rigid. With such a configuration, the blades 36a,b may be made relatively thin, while still providing sufficient rigidity. For example, each blade 36a,b may have a thickness in the range of 0.4 to 0.6 inches. As another example, each blade 36a,b may have a thickness in the range of 0.4375 to 0.5625 inches.

Each blade 36a,b may also have a second end 46 opposite the first end 44, and each second end 46 may be connected to the shaft 32 in any suitable manner, such as by welding and/or with adhesive. Each second end 46 may terminate at the shaft 32 as shown in FIG. 1, or extend beyond the shaft 32 as shown in FIG. 3. Furthermore, for each blade unit 34, the shaft 32, associated blades 36a,b and connector member 42 may cooperate to define a box-type configuration.

Referring to FIG. 4, each blade 36 may have any suitable configuration. For example, each blade 36a,b may have a generally parallelogram cross-section, a blade depth or projection depth D in the range of 0.4375 to 1.5625 inches, and a blade height H in the range of 0.5125 to 0.6375 inches. As another example, each blade 36 may have a blade depth to blade height ratio in the range of 0.65 to 3.0, or more specifically in the range of 2.45 to 2.8. As yet another example, each blade 36 may have any suitable size and shape.

By using blades 36 that each have a relatively small depth D and a relatively small height H, blade projection area into the materials to be mixed can be reduced or minimized. As a result, drag can be reduced or minimized, and load on the motor 30 can be reduced or minimized.

Furthermore, by using multiple blade units 34 that each include multiple blades 36, mixing ability may be maximized. For example, such a configuration may result in enhanced screw or auger-type mixing and improved flow.

In addition, for each blade unit 34, the corresponding blades 36a,b may be generally aligned horizontally. In that regard, leading and trailing edges or corners of the associated blades 36a,b may be generally aligned as shown in FIG. 4. The leading edges and other corners of the blades 36 may also be rounded, if desired, to remove sharp edges.

Referring to FIG. 5, the blade units 34 may be staggered about the shaft 32. For example, the blade units 34 may be spaced equally apart. In that regard, the blade units 34 may be spaced apart by 360 degrees divided by the number of blade units 34. In the embodiment shown in FIG. 5, the blade units 34 are angularly spaced apart by approximately 120 degrees. Such a configuration may provide a balanced load on the shaft 32.

Returning to FIGS. 1 and 2, the mixing assembly 14 may further include a motor encasement or cover 48 for covering the motor 30, and a controller or control unit 50 for controlling operation of the motor 30. In the embodiment shown in FIGS. 1 and 2, the motor cover 48 is attached to the cover 18 with one or more fasteners 52, and the motor cover 48 cooperates with the cover 18 to sufficiently encase the motor 30. The motor cover 48 may also be provided with one or more handles to facilitate removal of the motor cover 48 and cover 18.

In the embodiment shown in FIGS. 1 and 2, the control unit 50 is mounted on the motor cover 48, and is connected to the motor 30 in any suitable manner, such as with wiring. Furthermore, the motor 30 and/or the control unit 50 may be configured to be plugged into an electrical outlet, such as a standard wall electric outlet. In other embodiments, the motor 30 and/or the control unit 50 may be configured to be plugged into a power converter and/or an industrial outlet for larger scale usage.

As mentioned above, the control unit 50 is configured to control operation of the motor 30. In that regard, the control unit 50 may be used to start and stop the motor 30, and may also be provided with a timer that automatically shuts the motor 30 off after a set amount or predetermined amount of operation. For example, the control unit 50 may include start and stop buttons, as well as buttons for setting and/or resetting the timer. Furthermore, the control unit 50 may include a display, such as an LCD display, for displaying control functions and/or parameters, such as mixing time.

Because the motor 30 and motor cover 48 are connected to the cover 18, the cover 18 may be considered part of the mixing assembly 14. As another example, the motor cover 48 may be considered part of the container arrangement 12.

Referring to FIGS. 1-5, operation of the mixer 10 will now be described in detail. First, any suitable material may be introduced into the container 16, such as pizza sauce concentrate and water. As another example, flour and water may be introduced into the container 16. Next, the cover 18 may be positioned on and attached to the container 16 such that the mixing assembly 14 extends into the container 16.

Referring to FIGS. 1 and 2, the motor 24 may then be activated using the control unit 50. For example, the start button on the control unit 50 may be pressed to operate the motor 30 for a predetermined amount of time, such as five minutes. As another example, appropriate buttons may be pressed to set a desired operation time for the motor 30.

The motor 30 may provide any suitable torque output for rotating the shaft 32 and blade units 34. For example, the motor 30 may provide a torque output in the range of 11.0 to 13.4 N-m. Furthermore, the motor 30 may be configured to rotate the shaft 32 and blade units 34 at any suitable speed, such as 115 to 135 revolutions per minute.

Once activated, the motor 30 may rotate the shaft 32 and blade units 34 in a first direction 52 about axis 54. Because the blades 36a,b of the blade units 34 may slope downwardly, rotation of the blades 36a,b in the first direction 52 may cause the blades 36a,b to move material upwardly. Furthermore, the lower edge 38 of the lower blade 36a of the first blade unit 34a may be positioned relatively close to a bottom interior surface 56 of the container 16 to provide effective scraping action. For example, the lower edge 38 of the lower blade 36a of the first blade unit 34a may be positioned about 0.0625 to 0.1875 inches from the bottom surface 56. As another example, the lower edge 32 of the lower blade 30a of the first blade unit 28a may be positioned ⅛ of an inch or less from the bottom surface 56.

The motor 30 may also be configured to rotate the shaft 32 and blade units 34 in a second direction opposite the first direction 52. In such case, the blade units 34 may move material downwardly. Rotation of the blade units 34 in the second direction may also be used at the end of a mixing operation to expel material that may be adhered or otherwise stuck to one or more of the blades 36.

The mixer 10 may be made of any suitable materials and in any suitable manner. For example, the container 16 and cover 18 may be made of injection molded plastic, such as polycarbonate or high density polyethylene. Such a container arrangement 12 is available from Cambro Manufacturing Company of Huntington Beach, Calif.

As another example, the container 16 and/or cover 18 may be made of metal, such as aluminum or sand-cast stainless steel. Such material may provide increased support for the mixing assembly 14. In addition, the latches 20 may be made of metal, such as aluminum or stainless steel.

The mixing assembly 14 may also be made of any suitable materials and in any suitable manner. For example, the shaft 32 and blade units 34 may be made from metal, such as aluminum or sand cast stainless steel. Use of stainless steel, for example, may provide good corrosion resistance and material strength characteristics. As another example, the shaft 32 and blade units 34 may be made of plastic, such as injection molded polyvinylchloride. As yet another example, the motor cover 48 and housing of the control unit 50 may be made of plastic, such as thermo-formed high density polyethylene.

Furthermore, each blade unit 34, including the associated blades 36 and connector member 42, may be made as a single piece. As another example, each blade unit 34 may be made of multiple pieces that are joined together in any suitable manner, such as with adhesive and/or welds.

While exemplary embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, a mixer according to the present disclosure may be provided with multiple blade units that each include three or more blades. Additionally, the features of various implementing embodiments may be combined to form further embodiments of the invention.

What is claimed is:

1. A mixer comprising:
a container for receiving material to be mixed; and
a mixing assembly configured to extend into the container, the mixing assembly including a rotatable shaft and multiple blade units connected to the shaft, each blade unit including multiple parallel blades.

2. The mixer of claim 1 wherein each blade is angled downwardly.

3. The mixer of claim 2 wherein each blade is angled downwardly at least twenty-five degrees relative to a horizontal line.

4. The mixer of claim 2 wherein each blade is angled downwardly by about thirty degrees relative to a horizontal line.

5. The mixer of claim 1 wherein each blade has a first end remote from the shaft, and wherein for each blade unit the first ends of the respective blades are connected together.

6. The mixer of claim 5 wherein each blade has a second end opposite the first end, and wherein each second end extends beyond the shaft.

7. The mixer of claim 1 wherein each blade has a first end remote from the shaft, and each blade unit further includes a connector member that connects the first ends of the respective blades, and wherein for each blade unit, the shaft, the connector member and the respective blades form a box-type configuration.

8. The mixer of claim 7 wherein each blade unit is integrally formed as a single piece.

9. The mixer of claim 1 wherein the multiple blade units include three blade units that are offset vertically with respect to each other.

10. The mixer of claim 9 wherein the blade units are angularly spaced apart about the shaft, and each blade unit includes two blades.

11. The mixer of claim 1 wherein each blade has a blade depth and a blade height, and wherein each blade has a blade depth to blade height ratio in the range of 2.45 to 2.8.

12. The mixer of claim 1 wherein each blade comprises stainless steel.

13. A mixer comprising:
a container for receiving material to be mixed; and
a mixing assembly configured to extend into the container, the mixing assembly including a rotatable shaft and multiple blade units connected to the shaft, each blade unit including multiple, spaced apart parallel blades that are each angled downwardly at least twenty-five degrees relative to a horizontal line, wherein each blade has a distal end remote from the shaft, and wherein for each blade unit the distal ends of the respective blades are connected together.

14. The mixer of claim 13 wherein the multiple blade units include three blade units that are offset vertically with respect to each other.

15. The mixer of claim 14 wherein the blade units are angularly spaced apart about the shaft.

16. The mixer of claim 13 wherein the multiple blade units include first, second and third blade units, each blade unit includes a lower blade and an upper blade, and each blade has an upper edge and a lower edge, and wherein the upper edge of the upper blade of the first blade unit is generally coplanar with the lower edge of the lower blade of the second blade unit, and the upper edge of the upper blade of the second blade unit is generally coplanar with the lower edge of the lower blade of the third blade unit.

17. The mixer of claim 13 wherein each blade has a blade depth and a blade height, and wherein for each blade the ratio of the blade depth to the blade height is in the range of 2.45 to 2.8.
